(19) United States
(12) Patent Application Publication
(10) Pub. No.: US 2026/0065875 A1
(43) Pub. Date: Mar. 5, 2026

(54) DEVICE AND METHOD FOR AUTOMATICALLY CHANGING DISPLAY ORIENTATION OF COMPUTER MONITOR

(71) Applicant: AUTOLITH INC., Toronto (CA)

(72) Inventor: Mitchell Gordon OTTAWAY, Toronto (CA)

(21) Appl. No.: 19/301,165

(22) Filed: Aug. 15, 2025

Related U.S. Application Data
(60) Provisional application No. 63/683,987, filed on Aug. 16, 2024.

(51) Int. Cl. G09G 5/00; G06F 3/0346

(52) U.S. Cl. CPC G09G 5/006; G06F 3/0346; G09G 2330/02; G09G 2340/0492

(57) ABSTRACT

Device and method for automatically rotating the orientation of the display output of a computer monitor in response to a change in the physical orientation of the computer monitor. The device attaches to a computer monitor that is connected to a computer. The device detects changes in the physical orientation of the computer monitor by polling (i.e., repeatedly pinging) a physical orientation detector/sensor. The device may comprise an accelerometer, an inertial measurement unit (IMU), and/or a gyroscope. When a material change in the physical orientation of the monitor is detected (a material change being a difference in orientation that exceeds a predetermined threshold), the device sends instructions to the computer to change the orientation of the computer monitor's display output. The instructions may be sent wirelessly or over a wired connection. The instructions sent to the computer may be tagged with an identification code that uniquely identifies the computer monitor.

### RELATED APPLICATIONS

This application claims priority to and the benefit of U.S. Provisional Application No. 63/683,987, filed on Aug. 16, 2024.

### TECHNICAL FIELD

The present invention relates to computer monitors. More specifically, the present invention relates to automatically changing an orientation of a display output of a computer monitor in response to a change in the monitor's physical orientation.

### BACKGROUND

Many desktop computer monitors are physically rotatable, via stands, mounting arms, or other rotatable connections. Additionally, as may be understood, users of such computer monitors may frequently wish to adjust the orientation of their devices. For example, some data is more easily viewed using a computer monitor in landscape (horizontal) mode while other data is more easily viewed using a computer monitor in portrait (vertical) mode. Thus, some users may rotate their monitors several times a day or more.

Although many portable electronic devices (such as most tablets and smartphones) provide display autorotation, no such systems generally exist for computer monitors that are intended for non-portable (i.e., desktop) deployment. Thus, changing the orientation of the display output of a computer monitor following a physical rotation of the computer monitor remains a manual process. That is, even if the computer monitor is physically rotated into portrait mode from landscape mode, the monitor's display will remain in landscape mode until the display settings are manually changed by the user. This process typically involves several steps, which may be briefly outlined as follows:
i. the user opens the Settings menu (or equivalent menu) of their operating system;
ii. the user navigates though that Settings menu to the Display or Graphics section, which may involve several steps;
iii. if the user has multiple displays/monitors, the user must select the specific display they wish to adjust;
iv. the user selects a new orientation for the selected display output;
v. the user confirms the new orientation of the display output; and
vi. the user exits the Settings menu and returns to what they were doing.

While this process, performed once, is not onerous, repeating each of these steps whenever a change in orientation is desired can become extremely time-consuming. This process can be particularly time-consuming and tedious for users who have more than one computer monitor in their setup.

There is therefore clearly a need for devices, systems, and methods that provide autorotation functions for computer monitors.

### SUMMARY

This document discloses a device and method for automatically rotating the orientation of the display output of a computer monitor in response to a change in the physical orientation of the computer monitor. The device attaches to a computer monitor that is connected to a computer. The device detects changes in the physical orientation of the computer monitor using a physical orientation detector/sensor. For example, the device may comprise an accelerometer, an inertial measurement unit (IMU), and/or a gyroscope. When a material change in physical orientation is detected (a material change being a difference in physical orientation that exceeds a predetermined threshold), the device sends instructions to the computer to change the orientation of the computer monitor's display output in the computer's settings. In some embodiments, the predetermined threshold is 15° radially in either direction. The instructions may be sent wirelessly or over a wired connection. The instructions sent to the computer may be tagged with an identification code that uniquely identifies the computer monitor.

In a first aspect, this document discloses a device for changing an orientation of a display output of a computer monitor, said computer monitor being connected to a computer and said device being physically connected to said computer monitor, wherein the device comprises:
a processing unit, said processing unit having access to current physical orientation data for said computer monitor;
a data transmission unit in communication with said processing unit and in communication with said computer;
a physical orientation detector in communication with said processing unit; and
a power unit for powering said processing unit, said data transmission unit, and said physical orientation detector.

In some embodiments, this document discloses a device wherein, when said device is activated:
said processing unit sends a request to said physical orientation detector,
responsive to said request, said physical orientation detector sends new orientation data to said processing unit;
said processing unit compares said new orientation data to said current orientation data to thereby obtain a difference in orientation; and
when said difference in orientation exceeds a predetermined threshold, said processing unit directs said data transmission unit to send instructions to said computer, wherein said instructions instruct said computer to change said orientation of said display output of said computer monitor.

In some embodiments, this document discloses a device wherein said processing unit, said data transmission unit, and said physical orientation detector are contained within a housing.

In some embodiments, this document discloses a device wherein said processing unit, said data transmission unit, and said physical orientation detector are arranged on a printed circuit board.

In some embodiments, this document discloses a device wherein said processing unit and said data transmission unit form a single physical unit.

In some embodiments, this document discloses a device wherein said data transmission unit communicates wirelessly with said computer.

In some embodiments, this document discloses a device wherein said data transmission unit communicates with a wireless receiver, said wireless receiver being coupled to said computer.

In some embodiments, this document discloses a device wherein said data transmission unit communicates using the Bluetooth protocol.

In some embodiments, this document discloses a device wherein said data transmission unit communicates with said computer through an at least partially wired connection.

In some embodiments, this document discloses a device wherein said power unit comprises a battery.

In some embodiments, this document discloses a device wherein said battery is rechargeable.

In some embodiments, this document discloses a device wherein said device is automatically activated when said computer is powered on.

In some embodiments, this document discloses a device wherein said housing comprises a power switch and said device is manually activated by use of said power switch.

In some embodiments, this document discloses a device wherein said physical orientation detector comprises at least one of: an accelerometer, an IMU, and a gyroscope.

In some embodiments, this document discloses a device wherein said instructions are tagged with an identification code, said identification code uniquely identifying said computer monitor such that said instructions are uniquely associated with said computer monitor.

In some embodiments, this document discloses a device wherein said identification code is automatically extracted from metadata of said computer monitor.

In some embodiments, this document discloses a device wherein said housing comprises at least one external indicator.

In some embodiments, this document discloses a device wherein said at least one external indicator is an LED.

In some embodiments, this document discloses a device wherein said instructions are configured for at least one of: receipt by a purpose-built software package installed on said computer, said software package being in communication with an operating system of said computer; and direct receipt by an operating system of said computer.

In another aspect, this document discloses a method for automatically changing an orientation of a display output of a computer monitor, said computer monitor being connected to a computer, said method comprising:
(a) determining, at a processing unit physically connected to said computer monitor, current orientation data of said computer monitor;
(b) receiving, by said processing unit, new orientation data from a physical orientation detector, said physical orientation detector also being physically connected to said computer monitor and said physical orientation detector being connected to said processing unit;
(c) comparing said new orientation data to said current orientation data to thereby obtain a difference in orientation; and
(d) when said difference in orientation exceeds a predetermined threshold, sending instructions from said processing unit to said computer, wherein said instructions instruct said computer to change said orientation of said display output of said computer monitor.

In some embodiments, this document discloses a method wherein steps (b) to (d) are repeated according to a predetermined schedule.

In some embodiments, this document discloses a method wherein steps (b) to (d) are performed after said new orientation data is collected by said physical orientation detector.

In some embodiments, this document discloses a method wherein step (d) further comprises sending an identification code from said processing unit to said computer, wherein said identification code uniquely identifies said computer monitor such that said instructions are uniquely associated with said computer monitor.

In another aspect, this document discloses a system comprising: a computer; a plurality of computer monitors connected to said computer; and a plurality of devices as described herein, wherein each of said plurality of devices is physically connected to a respective one of said plurality of computer monitors, wherein each of said plurality of computer monitors has a unique identification code, and wherein instructions sent from each of said plurality of devices to said computer are tagged with an identification code identifying said respective one of said plurality of computer monitors.

### BRIEF DESCRIPTION OF THE DRAWINGS

The present invention will now be described by reference to the following figures, in which identical reference numerals refer to identical elements and in which:

FIG. 1 is a block diagram of a device according to one aspect of the invention;

FIG. 2 is a schematic diagram of an exemplary implementation of the device of FIG. 1;

FIG. 3 is a circuit design for the schematic of FIG. 2;

FIG. 4 is a schematic diagram of another exemplary implementation of the device of FIG. 1;

FIG. 5 is a perspective view of an exemplary housing for the device of FIG. 1;

FIG. 6 is a top view of the housing of FIG. 5; and

FIG. 7 is a method according to another aspect of the invention.

### DETAILED DESCRIPTION

The present invention provides a device and method for automatically rotating the orientation of the display output of a computer monitor in the computer settings in response to a change in the physical orientation of the computer monitor. The device attaches to a computer monitor that is connected to a computer. The device detects changes in the physical orientation of the computer monitor by polling (i.e., repeatedly pinging) a physical orientation detector/sensor. For example, the device may comprise an accelerometer, an inertial measurement unit (IMU), and/or a gyroscope. When a material change in the physical orientation of the computer monitor is detected (a material change being a difference in orientation that exceeds a predetermined threshold), the device sends instructions to the computer to change the orientation of the computer monitor's display output via the computer settings. The instructions may be sent wirelessly or over a wired connection.

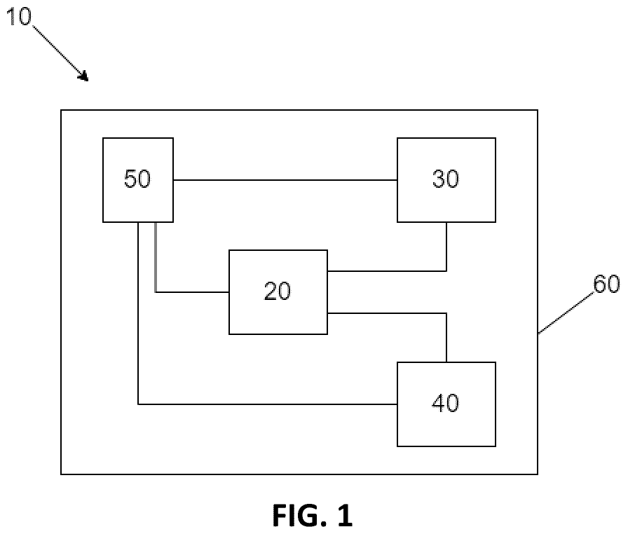

FIG. 1 is a block diagram of such a device 10. A processing unit 20 is in communication with a data transmission unit 30 and a physical orientation detector 40. A power unit 50 provides power to the components of the device 10. The components of the device 10 may be contained within a housing 60.

The components of the device 10 may be arranged on a printed circuit board (PCB), though other arrangements of the components of the device 10 are possible. The PCB may have any desired shape, size, or other form factor. As one non-limiting example, the PCB may be rectangular. As another non-limiting example, the PCB may be circular. As should be understood, the housing 60 is preferably similar in shape to the PCB, such that housing material is not wasted. As such, when the PCB is rectangular, the housing 60 is preferably generally rectangular as well. Similarly, when the PCB is circular, the housing 60 is preferably generally circular as well. Again, regardless of shape, the PCB (or other component arrangement) preferably fits securely in the housing 60 with little extra space.

The device and/or components thereof may also be contained within the computer monitor/other display device. For example, the computer monitor may contain a PCB and or a housing 60 having a PCB contained therein, as described above. As another example, the computer monitor may contain the components of the device 10 (i.e., the processing unit 20, the data transmission unit 30, and the physical orientation detector 40) as separate elements. For example, the data transmission unit 30 in such configurations may be pre-existing data transmission modules of the computer monitor, while the physical orientation detector 40 and/or processing unit 20 may be special-purpose additions to the computer monitor. As another example, the device and/or components thereof may also be attached to the computer monitor by way of attachment to a monitor stand/supporting arm. As some examples of such configurations, a monitor stand could have a physical orientation detector 40 (such as a visual sensor or a rotational sensor (e.g., a Hall effect sensor)) attached to a rotational joint or longitudinal extension of the stand. Such a device could be connected to the computer as described below. Additionally, in some embodiments, the device 10 may be fully integrated with the monitor stand/supporting arm rather than attached thereto. For example, the monitor stand/supporting arm may comprise various electronics, including without limitation electronic components that perform the functions of the present device. In such embodiments, rotation of the monitor/display device would trigger the rotation of the electronic display based on detection of the rotation by the electronic components within the arm/stand. The references to the device 10 herein are not intended to exclude such embodiments of the invention.

It should also be noted that the computer monitor/display device(s) with which the present device is to be used is a display device/display monitor that is not configured to run an operating system. Rather, the display device/display monitor is configured for connection to a computer that runs an operating system.

The processing unit 20 of the device 10 may comprise any suitable processing unit. In some embodiments, the processing unit 20 comprises a microcontroller.

The data transmission unit 30 comprises a unit capable of communicating with the computer and the processing unit 20. As should be understood, the data transmission unit 30 is preferably configured for wireless communication with the computer, as not having wires would facilitate easy rotation of the computer monitor. However, the data transmission unit 30 may also be configured for wired transmission, either instead of or in addition to wireless transmission. The data transmission unit 30 may comprise a radio (RF) transmitter/antenna capable of wireless transmission to the computer. Such a radio transmitter may comprise a Bluetooth transmitter/receiver. Alternatively and/or additionally, the data transmission unit 30 may comprise a unit for transmitting data to the computer through a wired connection. In such embodiments, the data transmission unit 30 may therefore also comprise buses, ports, and/or other wired data transmission elements. Of course, any suitable short range data transmission technology may be used with the present invention.

Additionally, the processing unit 20 and the data transmission unit 30 may comprise a single physical unit/chip/assembly/module. For example, a microcontroller and a Bluetooth-enabled transmitter may be combined on a single assembly that performs the functions of both the processing unit 20 and the data transmission unit 30.

The physical orientation detector 40 is a sensor for determining a physical orientation of an object in space. Such detectors/sensors are well-known in the field of electronic devices and may include, without limitation, accelerometers, inertial measurement units (IMU), and gyroscopes. The physical orientation detector 40 may comprise any such detector/sensor or a combination of multiple detectors/sensors. If multiple detectors/sensors are present, all of the multiple detectors/sensors can be the same type of sensor. However, the multiple detectors/sensors can also comprise different types of sensors.

The power unit 50 may comprise a battery. Further, in some embodiments, the power unit 50 may comprise a rechargeable battery. Alternatively and/or additionally, the power unit 50 may comprise a power transmission relay for wired power transmission from an external power source. In such embodiments, as may be understood, the device 10 may draw power from a power source of the computer monitor, from the computer, or from another power source.

When the power unit 50 comprises a rechargeable battery (i.e., a lithium-ion battery), various supporting elements may also be included in the power unit 50. For example, a dedicated integrated circuit (IC) for charging the rechargeable battery may be included in the power unit 50. Similarly, a holder for retaining the battery may also be included in the power unit 50. Additionally, the power unit 50 may comprise any needed components for transferring power to the various other components of the device 10. The power unit 50 may thus be connected to a port (not shown in FIG. 1) on the exterior of the housing 60. The port may facilitate charging of a rechargeable battery and/or may facilitate the provision of wired power directly to the components of the device 10. In some embodiments, the power unit 50 comprises replaceable batteries (i.e., conventional dry cell batteries such as cylindrical AA or AAA batteries, button cell batteries, etc.). When replaceable batteries are used in the power unit 50, at least a portion of the housing 60 can, preferably, be opened, such that the batteries can be replaced.

The housing 60 is preferably made of a weatherized and/or sturdy material, such as metal or plastic, such that the internal components of the device 10 are protected from wear and tear, drops, spills, and other minor damage. Some embodiments of the housing are made of acrylonitrile butadiene styrene (ABS), polycarbonate (PC) or polycarbonate blend (PCB) plastics, polyamide (PA), and/or combinations thereof.

The housing 60 may be attached to the computer monitor by any suitable method, including without limitation, adhesives, fasteners, straps, and so on. The housing 60 may be either permanently or removably attached to the computer monitor. Additionally, the housing 60 and the device 10 generally are, in some embodiments, suitable for retrofitting pre-existing computer monitors. Further, as noted above, the housing 60 and/or components of the device 10 may be integrated into the computer monitor, into a stand or mount for the computer monitor, and/or otherwise physically connected to the computer monitor. It should be clear that the mechanism of attachment/physical connection is not intended to limit the scope of the invention in any way.

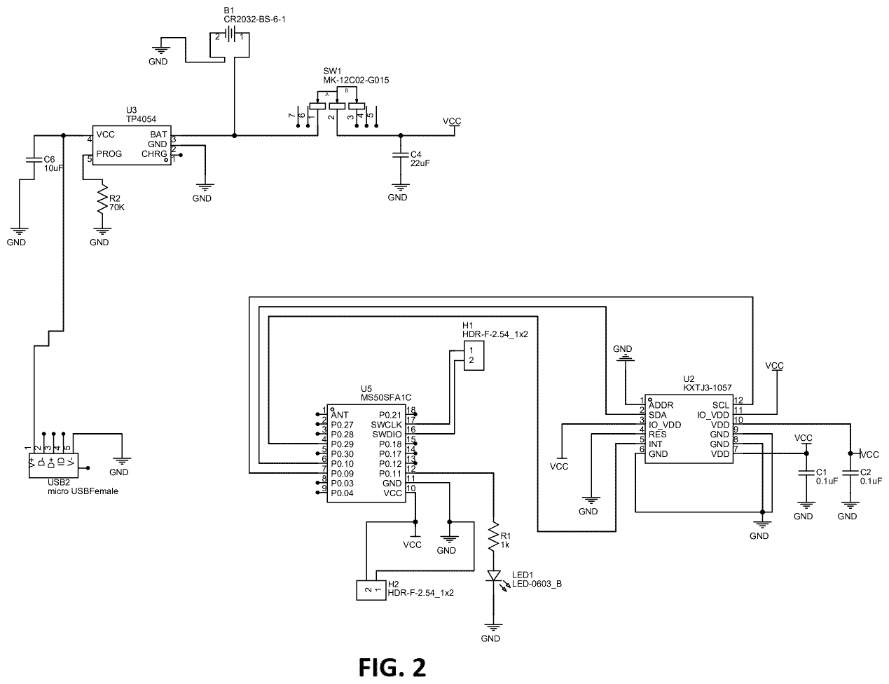

Turning now to FIG. 2, a schematic diagram of an implementation of the device 10 configured for wireless communication is shown. It should be understood that the specific parts and specifications of the specific parts used are not intended to limit the scope of the invention, nor should any of the exemplary implementations that follow be considered to limit the possible arrangements or configurations of the components of the device.

In the implementation shown in FIG. 2, a Minew™ MS50SFA1C™ assembly comprises a processing unit and a data transmission unit. The processing unit is a Nordic Semiconductor™ nRF52810™, based on the ARM™ Cortex™ M4™ architecture. The data transmission unit includes a 2.4 GHz wireless transceiver configured for transmissions over Bluetooth.

The Minew MS50SFA1C assembly shown in FIG. 2 is connected to a Kionix™ KXYJ3-1057™ accelerometer, which is used to detect the physical orientation of the device.

The power unit in the implementation of FIG. 2 (depicted at the upper left of the image) is a 3.6v Lithium Ion Rechargeable (LIR) 2032 battery. The battery is rechargeable through a micro-USB port (lower left of FIG. 2) and the charging is coordinated by a Top Power™ TP4054 circuit (a dedicated integrated circuit for constant-current/constant-voltage linear charging of LIR batteries). Voltage from the battery is fed directly to the MS50SFA1C assembly (which also includes a voltage regulator). Power is also provided from the battery to the accelerometer. The device in this implementation can perform at voltages between 1.7 VDC and 3.6 VDC (inclusive).

The power unit also comprises a battery holder (not shown) suitable for retaining the battery. As one example, the battery holder may comprise a CR2032-BS-6-1 holder (i.e., a holder for CR2032 batteries, which are the same size as LIR2032 batteries). Of course, the type of battery used will determine what type, size, shape, etc. of holder may be included.

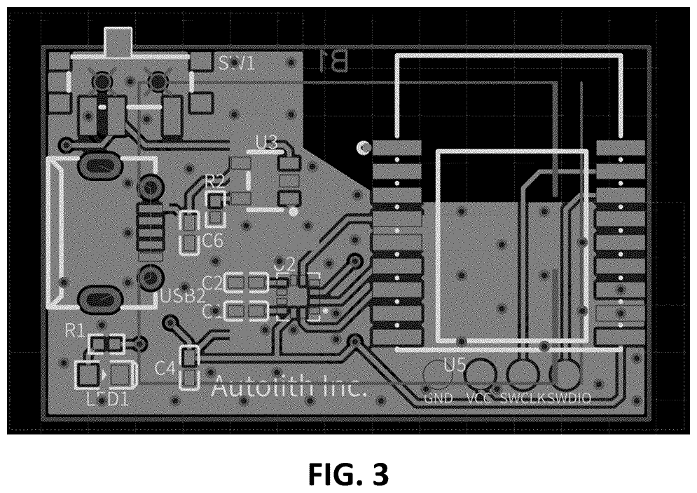

FIG. 3 shows a circuit design for a PCB that implements the schematic of FIG. 2. Again, nothing in this figure should be considered to limit the scope of the invention with respect to configuration, size, shape, or components of the device.

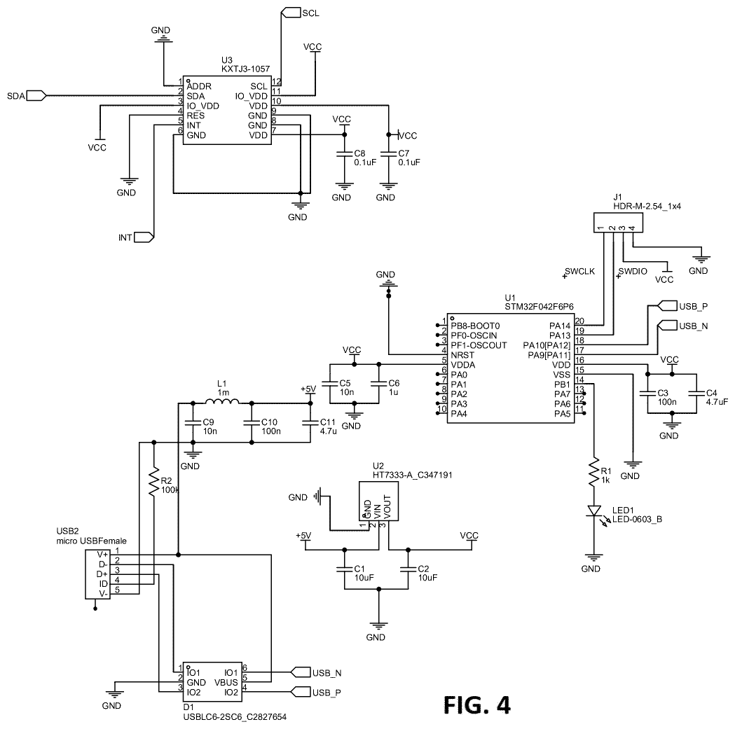

FIG. 4 is a schematic diagram of an implementation of the device 10 configured for wired communication. This implementation is, again, non-limiting, and many other parts, assemblies, and components could be used in implementing wired versions of the device 10.

The implementation shown in FIG. 4 uses an STM32™ microcontroller unit (specifically, an STM32F042F6P6) as the processing unit. This microcontroller is again based on the ARM™ Cortex™-M architecture, and has 20 ports as shown. A separate voltage regulator (in this implementation, a Holtek Semicon™ HT7333-A_C347191) is used to regulate incoming voltage from the battery, as the STM32 does not have an onboard voltage regulator. Again, a Kionix™ accelerometer is used as the physical orientation detector. Communication with the computer is achieved using USB connections, as shown.

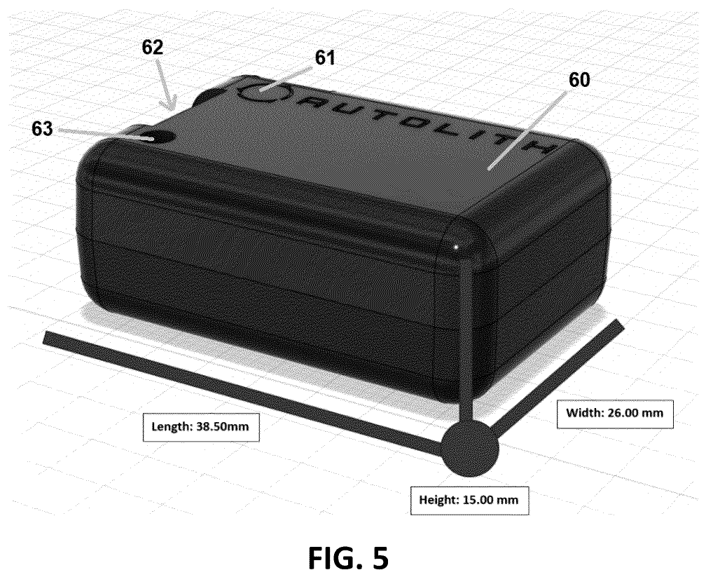

FIG. 5 depicts the housing 60 in more detail. In the embodiment shown, the housing 60 has a manual power button/power switch 61. As should be understood, the user may turn the device 10 on or off using this power switch 61. However, in other embodiments, the device 10 may be configured to turn on automatically whenever the connected computer is turned on, so that the user does not need to manually control the device activation. Such automatic activation may be preferable for users who make frequent adjustments to their computer monitors, but may have negative effects on the device's battery life.

The housing 60 may also have charging port(s) or power port(s) 62, as described above, into which a charging cable or power cable may be plugged. Additionally, the housing 60 may have one or more external indicators, such as LED indicators, that convey information to the user. The indicator(s) may indicate various conditions of the device 10, including without limitation:
a power state of the device (e.g., lit implying that the device 10 is on, and unlit implying that the device 10 is off);
a connection state of the device 10 (e.g., indicators of certain colours may indicate successful connections while indicators of different colours (or unlit indicators) may indicate failed connections); and/or
a rotation detection by the device 10.

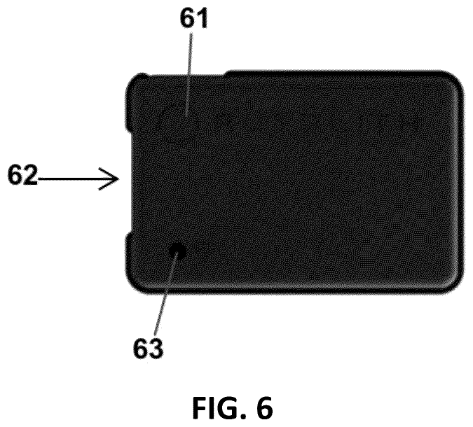

FIG. 5 includes specific dimensions for the housing 60, namely a length of 38.5 mm, a height of 15 mm, and a width of 26 mm. As should be understood, these are simply exemplary values and should not be considered to restrict the scope of the invention in any way. FIG. 6 is a top-down view of the housing of FIG. 5, again showing the power switch 61, the port(s) 62, and the indicator 63.

### Method and Computer Communication

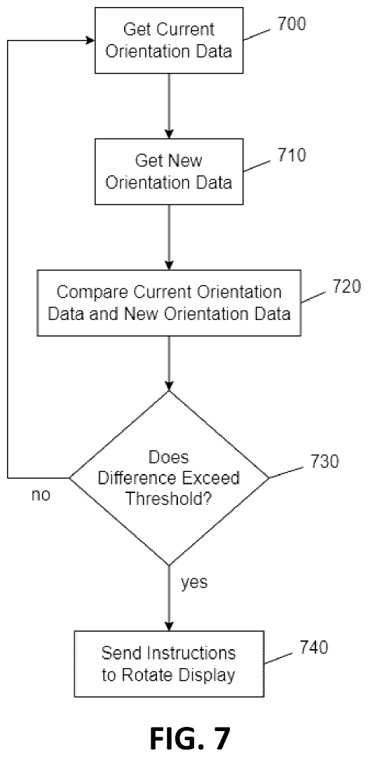

FIG. 7 is a flowchart detailing a method according to one aspect of the invention, and that can be implemented by the device 10. At step 700, current physical orientation data is obtained. At step 710, new physical orientation data is obtained. The new orientation data and the current orientation data are compared to each other at step 720, and a difference in orientation is obtained. At decision 730, it is determined whether the absolute value of the difference in (physical) orientation exceeds a predetermined threshold. If the absolute value of the difference in orientation does exceed the threshold, this is interpreted as a change in the physical orientation of the computer monitor. In this case, the device 10 sends instructions to the computer at step 740. The instructions instruct the computer to change the orientation of the computer monitor's display output. However, if, at decision 730, it is determined that the absolute value of the difference in physical orientation does not exceed the threshold, the method returns to step 700. The previous ‘new’ physical orientation data from step 710 is then considered as the current physical orientation data for the next iteration of the method.

As one example, the computer monitor may be thought of as having four general physical orientations, corresponding to 0°, 90°, 180°, and 270° (i.e., two “portrait” modes and two “landscape” modes). Of course, it should be understood that these are relative orientations for conventional rectangular displays and should not be considered to limit the possible positioning of the computer monitor or the possible display orientations of data displayed on the computer monitor. In some embodiments, each of the four physical orientations may comprise a range of angles surrounding each specific position. For example, a range of +15° around each specific orientation angle would trigger the rotation of the display output when the physical rotation of the device approached a new specific orientation angle. In such an implementation, with the current physical orientation of the computer monitor assumed to be 0°, the computer monitor would not need to be moved exactly to 90° (or) 270° to trigger the rotation of the display output. Rather, in this implementation, the rotation of the display output would be triggered when the physical rotation of the computer monitor reaches 75° (or) 285°, i.e., within the +15° range. This allows more flexibility for the user.

In such an implementation, the threshold value used in decision 230 would be 60°. That is, with each orientation position corresponding to a range of #15° (i.e., in total, a 30° range around each of the four positions), the difference between the current orientation data and the new orientation data must exceed 60° to trigger a change in the orientation of the display output. Using a larger threshold (e.g., above) 45° helps to prevent the device 10 from mistaking one orientation for another and therefore prematurely changing the orientation of the data display. Further, a threshold/gap of such a size also prevents the system from attempting to rapidly change between data display orientations if the physical display is positioned exactly between two orientation positions. For example, a conventional approach might be to use an angular window of 90° around each orientation position. However, as can be imagined, if a user were to physically rotate the display to 45°, the display would be physically positioned exactly on the border between two ranges and could become trapped in a rotational display loop until the physical rotation was further adjusted. This could be highly inconvenient for the user.

There are, of course, many ways to evaluate the difference in physical rotation. In some implementations, current orientation data and new orientation data may be directly compared with each other, e.g., by subtraction of values in degrees, radians, etc. In other implementations, a placeholder “orientation category” value may be defined. Such an orientation category may be useful when there are specific predefined orientations, as in the examples above describing four distinct orientation modes. In such implementations, the orientation categories may be defined as “orientation 0”, “orientation 1”, “orientation 2”, “orientation 3”, or using any other numbering or classification scheme as may be suitable. In such a case, when the physical orientation is within one of the four ranges of angles (e.g., a 30° range as described above), the orientation category for the new orientation would be set to a corresponding category value (e.g., “2” when the physical orientation is within ±15° of) 180°. Then, the category value of the new physical orientation could be compared to the already-determined category value of the current physical orientation (e.g., “3”). Such a comparison, using only single-digit placeholders, would often be simpler than computing specific angular values and the absolute value of the rotation. An algorithm for such an implementation is detailed below (with “//” denoting commentary):

```
*current_orientation is already defined
Check_Device_Orientation( ) // Check orientation of accelerometer{
  acc_values = get_acc_values( ) // Processing unit communicates with
    accelerometer and retrieves values
  new_orientation = 0 //define new_orientation
  // Check if accelerometer values fall within the bounds of 1 of 4
  possible orientations
    if (acc_values == 90±15) {new_orientation = 1}
    else if (acc_values == 180±15) {new_orientation = 2}
    else if (acc_values == 270±15) {new_orientation = 3}
    else if (acc_values == 0±15) {new_orientation = 0}
  //Check if new_orientation equals old_orientation. If not, notify
  computer of new orientation and set old_orientation to
  new_orientation.
    if (new_orientation != old_orientation){
      notify_computer(new_orientation)
      old_orientation = new_orientation
    }
  }
```

Of course, however, any other suitable algorithm or implementation is within the scope of the invention.

The method can be performed indefinitely (provided that sufficient power is supplied, of course). Additionally, the step of getting new data and following steps may be performed continuously or may be performed according to a predetermined schedule. In one embodiment, new data may be received following a request for new data from the processing unit (i.e., the processing unit may regularly poll or ping the physical orientation detector and access its orientation data for comparisons). In other embodiments, the physical orientation detector may provide ‘interrupt’ signals to the processing unit. That is, the physical orientation detector may alert the processing unit whenever it receives new data, which the processing unit could then compare to the current orientation data.

Again, the threshold may be any suitable rotational value. In an implementation described above, the threshold is +60°, such that physical rotations greater than 60° away from an orientation range (i.e., from the 30° window) indicate that a change of display orientation/change of orientation of display output is needed. As should be understood, however, some users may wish to orient their computer monitors at specific angles of their own choosing without having the display orientation immediately flip. For example, some users may wish to orient a monitor at 80° without leaving the current display mode. Thus, the threshold may be user-configurable in some cases.

User-configurable settings may be facilitated through a purpose-built software package installed on the computer. In some embodiments, the device is configured to communicate only with such a software package, and the instructions sent to the computer are configured to be received and implemented by that software package. On receipt of the instructions, the software package would direct the display changes through communication with the computer's operating system. In other embodiments, the device 10 is alternatively or additionally capable of communicating directly with the operating system of the computer. In such embodiments, a purpose-built software package may not be required.

As described above, the device may communicate with the computer using either wired or wireless connections. Additionally, the device may communicate with a dedicated wireless receiver (or ‘dongle’) that is coupled to the computer through a USB port or other port. Such wireless receivers may use Bluetooth or other wireless communications standards and protocols.

### Device Binding

In some embodiments, the physical orientation data transmitted from the device to the computer is tagged with a unique identification code designating the specific display device/display monitor to which the device is connected. Additionally, in such embodiments, the instructions sent to the computer may also be tagged with the identification code, such that the computer may easily identify the source monitor.

The identification code is, in some embodiments, a user-generated or high-level identifier. However, in preferable embodiments, the identification code is a predetermined and/or machine-generated identifier that is unique to the display device. As one non-limiting example, the identification code may be extracted from metadata of the display device, such as Extended Display Identification Data (EDID), Enhanced EDID (E-EDID), or DisplayID formatted metadata. Such metadata frequently includes a unique serial number and/or a hash of such a serial number, either or both of which may be used as the identification code. The identification code may be co-transmitted with the instructions to the computer and/or included in related metadata of the instructions. Further, in embodiments where the computer receives raw orientation data from a physical orientation detector, that raw orientation data may be tagged with the identification code.

Including such an identification code with the transmitted instructions and/or physical orientation data enables the computer to accurately identify the source of the physical orientation data (i.e., to accurately determine which monitor or display such newly received orientation data relates to). As should be understood, the unique identification code may be more useful in multi-display embodiments than in single-display embodiments. That is, when there is only one display in the user's set-up, it can be assumed that any newly received orientation data relates to that display. However, when there is more than one display in the user's set-up, it may be more difficult to determine which of the multiple displays has moved/rotated or which of the multiple displays corresponds to specific orientation data. This is particularly useful in contexts where monitors are often connected to or disconnected from the computer system. That is, tagging all instructions/data received at the computer with unique identifiers corresponding to specific monitors helps to ensure that the orientation changes of any specific monitor trigger the desired display orientation changes on that specific monitor.

It should also be noted that high-level display names such as “Display 1”, “Display 2”, etc., are generally less useful as identifier codes. For example, a laptop computer may be plugged into a portrait-mode monitor for a portion of the user's day. Later, the laptop may be disconnected, taken to a second location, and connected to a different monitor that is in landscape mode. In both set-ups, the computer may designate the laptop's screen as Display 1 and the external monitor as “Display 2”, despite the fact that the two monitors are different devices with different physical orientations. Using a unique tag that is specific to the monitor, however, would avoid such conflict.

A device 10 configured to transmit a unique identification code for its monitor may be considered “bound” or “locked” to that monitor (regardless of its physical attachment to the monitor). This process of “device binding” may be initiated by the user or an administrator, and/or as an automatic process upon first connection of the device with the computer monitor/display device. Additionally, depending on the embodiment, the device binding may be resettable such that the device could be used with a different monitor/display device. However, as should be understood, each device would only be used with one monitor/display device at any one time.

### Interpretation

As used herein, the expression “at least one of [x] and [y]” means and should be construed as meaning “[x], [y], or both [x] and [y]”.

It should be clear that the various aspects of the present invention may be implemented as software modules in an overall software system. As such, the present invention may thus take the form of computer executable instructions that, when executed, implements various software modules with predefined functions.

Embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A device for changing an orientation of a display output of a computer monitor, said computer monitor being connected to a computer and said device being physically connected to said computer monitor, wherein the device comprises:
a processing unit, said processing unit having access to current orientation data for said computer monitor;
a data transmission unit in communication with said processing unit and in communication with said computer;
a physical orientation detector in communication with said processing unit; and
a power unit for powering said processing unit, said data transmission unit, and said physical orientation detector.

2. The device according to claim 1, wherein, when said device is activated:
said processing unit sends a request to said physical orientation detector,
responsive to said request, said physical orientation detector sends new orientation data to said processing unit;
said processing unit compares said new orientation data to said current orientation data to thereby obtain a difference in orientation; and
when said difference in orientation exceeds a predetermined threshold, said processing unit directs said data transmission unit to send instructions to said computer, wherein said instructions instruct said computer to change said orientation of said display output of said computer monitor.

3. The device according to claim 1, wherein said processing unit, said data transmission unit, and said physical orientation detector are contained within a housing.

4. The device according to claim 1, wherein said processing unit, said data transmission unit, and said physical orientation detector are arranged on a printed circuit board.

5. The device according to claim 1, wherein said processing unit and said data transmission unit form a single physical unit.

6. The device according to claim 1, wherein said data transmission unit communicates wirelessly with said computer.

7. The device according to claim 6, wherein said data transmission unit communicates with a wireless receiver, said wireless receiver being coupled to said computer.

8. The device according to claim 1, wherein said data transmission unit communicates with said computer through an at least partially wired connection.

9. The device according to claim 1, wherein said device is automatically activated when said computer is powered on.

10. The device according to claim 3, wherein said housing comprises a power switch and said device is manually activated by use of said power switch.

11. The device according to claim 1, wherein said physical orientation detector comprises at least one of: an accelerometer, an IMU, and a gyroscope.

12. The device according to claim 2, wherein said instructions are tagged with an identification code, said identification code uniquely identifying said computer monitor such that said instructions are uniquely associated with said computer monitor.

13. The device according to claim 2, wherein said identification code is automatically extracted from metadata of said computer monitor.

14. The device according to claim 3, wherein said housing comprises at least one external indicator.

15. The device according to claim 1, wherein said instructions are configured for at least one of:
receipt by a purpose-built software package installed on said computer, said software package being in communication with an operating system of said computer; and
direct receipt by said operating system of said computer.

16. A method for automatically changing an orientation of a display output of a computer monitor, said computer monitor being connected to a computer, said method comprising:
(a) determining, at a processing unit physically connected to said computer monitor, current orientation data of said computer monitor;
(b) receiving, by said processing unit, new orientation data from a physical orientation detector, said physical orientation detector also being physically connected to said computer monitor and said physical orientation detector being connected to said processing unit;
(c) comparing said new orientation data to said current orientation data to thereby obtain a difference in orientation; and
(d) when said difference in orientation exceeds a predetermined threshold, sending instructions from said processing unit to said computer, wherein said instructions instruct said computer to change said orientation of said display output of said computer monitor.

17. The method according to claim 16, wherein steps (b) to (d) are repeated according to a predetermined schedule.

18. The method according to claim 16, wherein steps (b) to (d) are performed after said new orientation data is collected by said physical orientation detector.

19. The method according to claim 16, wherein step (d) further comprises sending an identification code from said processing unit to said computer, wherein said identification code uniquely identifies said computer monitor such that said instructions are uniquely associated with said computer monitor.

20. A system comprising:
a computer;
a plurality of computer monitors connected to said computer; and
a plurality of devices according to claim 1,
wherein each of said plurality of devices is physically connected to a respective one of said plurality of computer monitors,
wherein each of said plurality of computer monitors has a unique identification code,
and wherein instructions sent from each of said plurality of devices to said computer are tagged with an identification code identifying said respective one of said plurality of computer monitors.
